(19) United States
(12) Patent Application Publication
(10) Pub. No.: US 2014/0343822 A1
(43) Pub. Date: Nov. 20, 2014

(54) ENGINE DIAGNOSTIC WITH EXHAUST GAS SAMPLING DELAY

(71) Applicant: JAGUAR LAND ROVER LIMITED, Warwickshire (GB)

(72) Inventor: Brian Varney, Whitley, Coventry, Warwickshire (GB)

(21) Appl. No.: 14/116,135

(22) PCT Filed: May 3, 2012
(86) PCT No.: PCT/EP2012/058171

§ 371 Date: Apr. 8, 2014

(30) Foreign Application Priority Data
May 11, 2011 (GB) 1107827.6

(51) Int. Cl. G01M 15/05

(52) U.S. Cl. CPC G01M 15/05
USPC 701/101

(57) ABSTRACT

A diagnostic method comprising the steps of: first sampling exhaust gas; implementing a forced change of engine operating condition; second sampling exhaust gas associated with said change at a delay after initiating said change, said second sampling being at a location corresponding to said delay; and comparing said first sampling and second sampling to detect a change in exhaust constituents.

### FIELD OF THE INVENTION

This invention relates to a diagnostic of a vehicle internal combustion engine, and particularly to a cam profile switching system of a gasoline engine. Aspects of the invention relate to a method, to a processor or electronic control unit, to an engine and to a vehicle.

### BACKGROUND

Internal combustion engines product harmful exhaust emissions, including CO, CO₂ and NOx. Vehicle engines are required to comply with legislative limits which prescribe the level of permitted emissions, typically over a standard driving cycle. The level of such emissions is being continually reduced.

A typical gasoline engine uses catalytically coated substrates in each exhaust system to minimize tailpipe emissions. Effective operation of these exhaust catalysts typically requires that the exhaust gas stream is maintained at near to stoichiometric air:fuel ratios. In support of this the engines are provided with closed loop feedback control of fuelling, whereby an oxygen sensor in the exhaust tract determines whether the exhaust gases have an oxygen content indicative of non-stoichiometric combustion. The sensor output is used to continually adjust fuelling of the engine to compensate for a lean or rich mixture—thus gas flow through the catalyst is generally maintained at or close to stoichiometric, and harmful emissions can be minimized.

Considerable advances have been made in closed loop feedback control of fuelling, but this approach can only correct fuelling after a departure from the target air:fuel ratio has been identified. Accordingly it is possible that if a large disturbance is experienced in the exhaust gas air:fuel ratio the storage capacity of the catalysts may be exceeded and some undesirable emissions may pass to atmosphere even if closed loop feedback control is fast and accurate.

Vehicle engines may have selectable features to permit operation in alternative modes. For example a dual camshaft arrangement can provide for low valve lift and higher valve lift to give a wider range of cam timing relationships over the engine load/speed map. A diagnostic is required to confirm operation of the correct mode, because otherwise the engine will have inappropriate valve timing and for example may be inappropriately fuelled; as a consequence harmful emissions may not be adequately controlled.

A diagnostic may for example rely upon analysis of exhaust gas during a momentary forced change of camshaft condition, whereby for example high lift mode is selected, thus allowing a different quantity of air to enter the respective cylinders. Combustion in these cylinders will be affected, with a consequent effect upon exhaust gas constituents. Thus in this example a change in exhaust composition can indicate correct operation of a high lift camshaft condition, whereas unchanged composition can indicate a malfunction.

A diagnostic of this kind must be periodically repeated in order to provide a regular check on correct operation of a cam switching arrangement. Each time the diagnostic is performed, a momentary increase in harmful emissions may occur since it is the change in exhaust constituents that allows correct cam switching to be confirmed. The diagnostic is advantageously performed for the minimum time period to give a reliable reading at the oxygen sensor, but nevertheless an increase in harmful emissions could still occur.

It is against this background that the present invention has been conceived. Embodiments of the invention may provide a method, a processor, a control unit or the like able to restrict the duration of such forced changes to the minimum commensurate with accurate diagnosis of the mode of engine operation. Other aims and advantages of the invention will become apparent from the following description, claims and drawings.

### SUMMARY OF THE INVENTION

According to one aspect of the invention, there is provided a method of assigning a delay between commencement of a momentary engine diagnostic and detecting the corresponding exhaust emissions at a defined location downstream of combustion, the delay being determined by one of:
determining from a look-up table the transit time of exhaust gases from a combustion chamber to said location by reference to engine speed;
determining from an algorithm the transit time of exhaust gases from a combustion chamber to said location by reference to engine speed;
counting engine revolutions corresponding to the transit time of exhaust gases from a combustion chamber to said location;
determining the mass of fuel entering a combustion chamber whereby said delay corresponds to a pre-determined threshold of the integrated fuel mass;
determining the mass of air entering a combustion chamber whereby said delay corresponds to a pre-determined threshold of the integrated air mass;
determining the mass of air/fuel mixture entering a combustion chamber whereby said delay corresponds to a pre-determined threshold of the integrated air/fuel mass, and
determining the volume of air entering a combustion chamber whereby said delay corresponds to a pre-determined threshold of the integrated air volume.

By ‘momentary’ we mean a minimum sufficient period for the cam profile switching system to generate a measurable change in the mass of air passing through the respective cylinders. This period will be engine specific, and can be determined empirically. For diagnostic purposes the momentary change should be as short as possible.

In one embodiment a cam profile switching system operates for 3-5 seconds, and the corresponding exhaust flow is analyzed for a period of 5-8 seconds to detect progressively the deviation of air flow and return to normal conditions.

In an embodiment, the method is for detecting degradation in a cam profile switching system of an internal combustion engine.

The delay corresponds to a time period and may be expressed directly or by reference engine revolutions, or air mass flow rate.

Knowing the delay allows sampling of the exhaust tract at a time corresponding to passage of exhaust gases which correspond to combustion conditions at commencement of the diagnostic. Thus the diagnostic can be momentary, and any effect upon combustion is minimized so far as possible. It may be possible for the diagnostic to cease before the exhaust gases corresponding to the diagnostic have been detected. Furthermore, the duration of the diagnostic can be minimized, so that it is less likely to be noticed by the vehicle driver.

The diagnostic of this aspect is intended to implement a change in engine combustion conditions, which is confirmed by a change of exhaust emissions at the downstream location. The diagnostic changes a mechanical condition of an engine by switching from one cam condition to another cam condition. A change of air flow will have an effect upon complete combustion, and detection of a change of exhaust constituents can indicate that the forced change of engine operating condition has been correctly effected.

The diagnostic may compare pre-diagnostic steady conditions with the change, or compare a momentary change with post-diagnostic steady conditions. In each case it is the difference which is relevant, and this can be determined as a momentary change from condition A to condition B or upon reversion from condition B to condition A.

The diagnostic may provide fuelling compensation during operation thereof whereby engine combustion conditions and corresponding exhaust emissions are substantially unchanged. In this case combustion will remain substantially stoichiometric and thus unchanged exhaust constituents can indicate that a forced change of engine operating condition has been correctly effected.

The invention provides different methods of assigning the delay, the appropriate method being typically selected according to the sensor signals available on the usual CANBUS or like control system, and/or according to which seems most advantageous from empirical testing. A measure of crank angle (engine revolutions) may for example be readily available from an ignition control system of the engine.

The accurate estimation of delay also provide other potential benefits. For example information concerning the rate of change of exhaust constituents may allow a qualitative assessment of the engine and/or second level diagnosis of fault conditions.

Thus, in the case of an engine with two alternative cam conditions, accurate estimation of the delay allows operation of a changed cam condition to be confirmed with minimum risk of an increase in harmful emissions, and with minimal operation of the engine in the alternative cam condition.

Accurate estimation of the delay also allows the rate of change of exhaust emissions to be evaluated as the alternative condition is engaged and disengaged. In the case of an alternative camshaft condition, the second level information may for example permit diagnosis of a lazy or sticking mechanism.

Knowing more accurately the delay, in terms of a time, engine revolutions or mass flow, the vehicle on-board diagnostic (OBD) can be improved for air/fuel mixture control, engine air flow (bank specific on a Vee engine, also known as a V-engine), duration of diagnostic, and completion of diagnostic.

According to another aspect of the invention there is provided a method of determining a delay associated with a diagnostic for detecting degradation in a cam profile switching system of an internal combustion engine,
said delay corresponding to a time period and being represented as one of a temporal duration, a change in crank angle and a mass of air passing through the engine induction tract,
wherein said delay is determined by one of calibration, a look-up table by reference to engine speed and load, and an algorithm with inputs of engine speed and load
and wherein said delay comprises one or more of:
a duration of measurement preparatory to a change of camshaft condition but subsequent to an initiation of said diagnostic;
a duration of measurement in a changed camshaft condition;
a duration associated with an indication that a measured parameter is stable;
a duration associated with an indication that a measured parameter is not stable;
a duration prior to change of camshaft condition within which all measured parameters should be stable;
a duration defining an averaging period for one or more measured parameters; and
a duration associated with an offset of fuel signal relative to lambda signal prior to calculation of air flow associated with a changed camshaft condition.

A delay may be associated with the time of initiation of the diagnostic, which may be defined as the commencement of the request for change of camshaft condition.

The delay associated with a duration indicative of a stable parameter provides an assurance that engine operating conditions are appropriate for the diagnostic. Conversely the diagnostic may be suspended, delayed or cancelled should one or more parameters be unstable. These parameters may be associated with entry conditions for initiation of the diagnostic.

The delay may be associated with exhaust gas transit duration (for example the duration of measurement in the changed camshaft condition).

Advantageous features of the invention are mentioned in the following description and in the claims appended hereto.

Within the scope of this application it is envisaged that the various aspects, embodiments, examples and alternatives, and in particular the individual features thereof, set out in the preceding paragraphs, in the claims and/or in the following description and drawings may be taken independently or in any combination thereof. Features described in connection with one embodiment are applicable to all embodiments unless such features are incompatible.

### BRIEF DESCRIPTION OF DRAWINGS

One or more embodiments of the invention will now be described, by way of example only, with reference to the accompanying drawing in which:—

FIG. 1 illustrates the typical delay dT between commencement of an engine diagnostic, and the occurrence of corresponding exhaust gases at an exhaust gas sensor.

A vehicle engine is typically controlled by an engine management system (EMS), and may have alternative modes of operation to suit different operational requirements. Some engines permit alternative camshaft conditions with variable value lift, so as to permit a wider range of cam timing relationships. A diagnostic is required to confirm correct operation of the mechanism switching between the alternative camshaft conditions.

Typically a gasoline engine will have closed loop fuel control whereby one or more exhaust sensors monitor the oxygen content of the exhaust gas stream. Ideally, for most conditions of use, combustion should be close to stoichiometric (lambda=1) and accordingly the output from the sensors can be used to continuously optimize fuelling of the engine by feedback control.

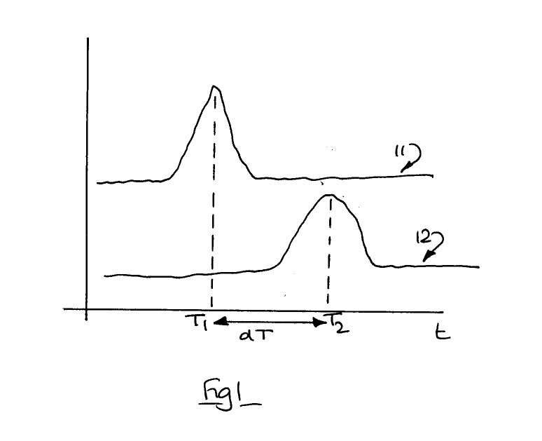

FIG. 1 illustrates the effect of a change in combustion conditions at time T₁. The upper characteristic (11) indicates a momentary spike of changed combustion conditions, and the lower characteristic (12) indicates a corresponding change of exhaust emissions at time T₂. The time dT represents the delay associated with passage of exhaust gas from the combustion chamber of the engine to the emissions sensor, and it will be appreciated that this delay is influenced by the distance of the sensors from the combustion chamber, and the speed of the exhaust gas flow.

In normal driving it will also be appreciated that fine adjustment of fuelling of the engine is more or less continuous as the ECM tries to match driver demand with minimal harmful exhaust emissions. By taking account of the delay dT, it is possible to provide better correlation of exhaust emissions and fuelling, so as to further minimize harmful emissions.

A diagnostic for determining camshaft condition may, for example, rely upon sensing a change in exhaust emissions as a consequence of a forced change of camshaft condition. Thus by switching camshaft condition, and knowing the fuelling regime, it is possible to recognize whether appropriate exhaust emissions are a resultant.

One possibility is that a camshaft condition is forced from low lift to high lift whilst monitoring a low lift fuelling regime. If the correct camshaft condition is not selected, for example due to a mechanical malfunction, exhaust emissions will be unchanged thus indicating the malfunction. In the alternative, a change in exhaust emissions indicates correct selection of the alternative camshaft condition. Thus can the output of the sensor be used as a diagnostic to indicate correct or incorrect operation of the mechanism for switching camshaft condition.

In an alternative the camshaft condition may be forced from low lift to high lift whilst implementing a high lift fuelling regime. In this case unchanged exhaust emissions are indicative of correct operation of the cam switching mechanism, whereas changed emissions are indicative of incorrect operation.

A diagnostic relying upon a forced change of this kind will generally be implemented when other conditions are not changing. Thus implementation whilst the driver is not making a throttle demand is typical.

This diagnostic should also be implemented for the minimum time, not least because it should be completed before a driver demands a change in fuelling. Furthermore a minimum time is also desirable to limit the risk of increased emissions and to minimize the period for which the vehicle engine is in a temporary forced condition.

In the present invention, the delay between commencement of the diagnostic and sensing of corresponding exhaust emissions can be determined by one or more of several possibilities, and may be selected according to convenient signals available on the CAN-BUS or other equivalent vehicle control system.

### 1. Exhaust Transit Time

In this embodiment a transit time to the exhaust gas sensor, in seconds, is determined from the commencement of the diagnostic, by reference to a look-up table stored in a memory of the ECM, or by reference to an algorithm relating transmit time to relevant factors. In both cases the principal factor influencing transmit time is engine speed (rpm). The skilled man will ensure that other minor factors are applied as required.

### 2. Counting Engine Revolutions

In this embodiment the delay is determined by counting engine revolutions (or part thereof) after commencement of the diagnostic. In general a pre-determined number of engine revolutions can be equivalent to the transmit time to the exhaust gas sensor. The skilled man may modify the number of engine revolutions according to other factors, such as instantaneous engine speed, by reference to a look-up table or algorithm. Crank angle is typically a readily available signal from the CAN-BUS or equivalent.

### 3. Mass Flow Rate

The instantaneous rate of flow of fuel into an engine is determined by the ECM, and accordingly the diagnostic may rely upon the passage of a pre-determined mass of fuel after commencement thereof. The mass of fuel may be determined from a look-up table or from an algorithm.

Likewise the instantaneous flow of air into an engine can be calculated from the exhaust gas sensor and the instantaneous fuel flow. Thus the diagnostic may rely upon the passage of a calculated mass of air after commencement thereof, by reference to look-up table or algorithm.

The diagnostic may combine these embodiments to indicate a delay by reference to a mass of air/fuel passing into the engine after commencement thereof.

This embodiment uses mass as a measure, but alternatively the measure may be expressed as a volume if the density of the fluid(s) is known.

The invention permits a delay to be determined, and accordingly in the described embodiment the exhaust gas sensor output can be sampled at the optimum time for relation to the commencement of the diagnostic.

The different methods disclosed herein allow the most appropriate determination of the or each delay according to the information and signals available to the ECM, and also permit more than one method to be used to give increased confidence and/or accuracy of such determination.

This application claims priority from UK patent application no. GB1107827.6, filed 11 May 2011, the entire contents of which are expressly incorporated by reference herein.

1. A method of detecting degradation in a cam profile switching system of an internal combustion engine, comprising assigning a delay between commencement of a momentary engine diagnostic and detecting the corresponding exhaust emissions at a defined location downstream of combustion, the delay being determined by one of:
determining from a look-up table the transit time of exhaust gases from a combustion chamber to said location by reference to engine speed;
determining from an algorithm the transit time of exhaust gases from a combustion chamber to said location by reference to engine speed;
determining a number of engine revolutions corresponding to the transit time of exhaust gases from a combustion chamber to said location;
determining the mass of fuel entering a combustion chamber whereby said delay corresponds to a pre-determined threshold of the integrated fuel mass;
determining the mass of air entering a combustion chamber whereby said delay corresponds to a pre-determined threshold of the integrated air mass;
determining the mass of air/fuel mixture entering a combustion chamber whereby said delay corresponds to a pre-determined threshold of the integrated air/fuel mass, and
determining the volume of air entering a combustion chamber whereby said delay corresponds to a pre-determined threshold of the integrated air volume.

2. A method of detecting a forced change of engine operating conditions by reference to a delay estimated by the method of claim 1, the method comprising the steps of:
first sampling exhaust gas;
implementing a forced change of engine operating condition;
second sampling exhaust gas associated with said change at a delay after initiating said change, said second sampling being at a location corresponding to said delay; and
comparing said first sampling and second sampling to detect a change in exhaust constituents.

3. A method as claimed in claim 2, wherein said first sampling is at a normal operating condition of the engine, and said second sampling is at an abnormal operating condition of said engine.

4. A method as claimed in claim 2, wherein said first sampling is at an abnormal operating condition of said engine, and said second sampling is at a normal operating condition of said engine.

5. A method as claimed in claim 2, wherein said first and second samplings are at a normal operating condition of the engine.

6. A method as claimed in claim 2, wherein the forced change of engine condition comprises a variation of inlet air flow.

7. A method as claimed in claim 6, wherein the variation of inlet air flow is momentary.

8. A method as claimed in claim 7, wherein said variation is ceased before expiry of said delay.

9. A method as claimed in claim 2, wherein the forced change is an alternative camshaft condition corresponding to a change of inlet valve lift.

10. A method as claimed in claim 2, performed in an electronic control module of an engine, said module having electronic inputs corresponding to one or more of:
instantaneous engine speed;
crank angle;
inlet fuel flow, and
exhaust air/fuel ratio at said location.

11. A method as claimed in claim 10, wherein the engine has a first exhaust tract for one group of cylinders, and a second exhaust tract for another group of cylinders, wherein said first sampling is taken for the first group, and said second sampling is taken for the second group.

12. A method as claimed in claim 11, wherein the engine is a V engine with separate exhaust tracts for each cylinder bank thereof.

13. A method as claimed in claim 12, wherein an oxygen sensor is provided in each respective exhaust tract.

14. An electronic control unit configured to perform a method of detecting degradation in a cam profile switching system of an internal combustion engine, comprising assigning a delay between commencement of a momentary engine diagnostic and detecting the corresponding exhaust emissions at a defined location downstream of combustion, the delay being determined by one of:
determining from a look-up table the transit time of exhaust gases from a combustion chamber to said location by reference to engine speed;
determining from an algorithm the transit time of exhaust gases from a combustion chamber to said location by reference to engine speed;
determining a number of engine revolutions corresponding to the transit time of exhaust gases from a combustion chamber to said location;
determining the mass of fuel entering a combustion chamber whereby said delay corresponds to a pre-determined threshold of the integrated fuel mass;
determining the mass of air entering a combustion chamber whereby said delay corresponds to a pre-determined threshold of the integrated air mass;
determining the mass of air/fuel mixture entering a combustion chamber whereby said delay corresponds to a pre-determined threshold of the integrated air/fuel mass, and
determining the volume of air entering a combustion chamber whereby said delay corresponds to a pre-determined threshold of the integrated air volume.

15. An engine or a vehicle having an electronic control unit or processor as claimed in claim 14.

16. (canceled)
